(19) United States
(12) Patent Application Publication
(10) Pub. No.: US 2026/0273975 A1
(43) Pub. Date: Sep. 17, 2026

(54) PRINTING APPARATUS, CONTROL METHOD, AND STORAGE MEDIUM

(71) Applicant: CANON KABUSHIKI KAISHA, Tokyo (JP)

(72) Inventor: Yumika NAKAMURA, Saitama (JP)

(21) Appl. No.: 19/561,714

(22) Filed: Mar. 10, 2026

(30) Foreign Application Priority Data
Mar. 14, 2025 (JP) 2025-041257

(51) Int. Cl. B41J 29/393; B41J 2/165; H02J 7/34

(52) U.S. Cl. CPC B41J 29/393; B41J 2/16508; B41J 2029/3932; B41P 2235/20; B41P 2235/27; H02J 7/345; H02J 2207/20; H02J 2207/50

(57) ABSTRACT

A printing apparatus, includes: a supply unit configured to supply power to a configuration configured to execute processing to perform printing; and a control unit configured to control power supplied from an external device to be output to the supply unit and a power storage unit configured to be capable of storing power supplied from the external device, wherein, in a case where printing is performed, the control unit is configured to execute outputting of power to the supply unit and the power storage unit in parallel until a predetermined timing in a case where power is supplied from the external device, and outputting of power stored in the power storage unit to the supply unit in a case where supply of power from the external device is stopped, so as to execute predetermined processing in accordance with an amount of power stored in the power storage unit.

### BACKGROUND

### Field of the Technology

The present disclosure relates to a printing apparatus, a control method, and a storage medium.

### Description of the Related Art

As a printing apparatus that performs printing by ejecting ink from a print head, a portable printing apparatus has been proposed which operates by receiving power supply from an external device or the like via an interface cable such as a USB cable, in order to support use applications such as outdoor use.

Japanese Patent Laid-Open No. 2017-205945 discloses a technology in which, at a timing of executing a sequence, power supplied from an external power source (an external device) via a USB cable is stored in a power storage part, and then the sequence is executed by utilizing the stored power.

However, with such a printing apparatus, at a timing such as moving the printing apparatus, the user unplugs the interface cable from the printing apparatus. In addition, the interface cable may be unplugged at a timing unintended by the user. Therefore, depending on a timing at which the interface cable is unplugged, the power supply of the printing apparatus may be cut off without performing processing on the print head. This may lead to deterioration in ejection performance of the print head, and at a next startup of the printing apparatus for printing, the printing quality may be deteriorated.

Therefore, in such a printing apparatus, in order to enable execution of maintenance processing for maintaining and recovering ejection performance of a print head even if an interface cable is unplugged during printing, power required for the maintenance processing is charged into a power storage part, and then the processing is started. However, in this case, the time period required for printing increases by the time period spent on charging of the power storage part.

### SUMMARY

The present disclosure is made in view of the above-mentioned problem, and provides a technology capable of suppressing an increase in the time period required for printing.

A printing apparatus, which includes a power storage unit configured to be capable of storing power supplied from an external device connected via a connection unit and is capable of executing processing to perform printing on a conveyed print medium by using the power as well as power stored in the power storage unit, includes: a supply unit configured to supply power to a configuration configured to execute the processing; and a control unit configured to control power supplied from the external device to be output to the supply unit and the power storage unit, wherein, in a case where printing is performed, the control unit is configured to execute outputting of power to the supply unit and the power storage unit in parallel until a predetermined timing in a case where power is supplied from the external device, and outputting of power stored in the power storage unit to the supply unit in a case where supply of power from the external device is stopped, so as to execute predetermined processing in accordance with an amount of power stored in the power storage unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic configuration diagram of a printing system;

FIG. 2 is a block diagram illustrating the configuration of a control system of a printing apparatus;

FIG. 3 is a block diagram illustrating the configuration of a power supply system of the printing apparatus;

FIG. 4 is a schematic configuration diagram of a printing part;

FIG. 5 is a flowchart illustrating an example of control processing for controlling charging and maintenance processing;

FIG. 6 is a flowchart illustrating the details of processing of the control processing according to the present embodiment;

FIG. 7 is a flowchart illustrating the details of processing of the control processing according to the present embodiment;

FIG. 8 is a table illustrating amounts of power supply for each connection standard;

FIGS. 9A and 9B are diagrams each illustrating a relationship, in a comparative example, between the amounts of power and time periods for respective processing during printing;

FIGS. 10A to 10D are diagrams each illustrating a relationship, in an exemplary embodiment, between the amounts of power and time periods for respective processing during printing; and

FIGS. 11A to 11D are diagrams each illustrating current flowing through a Charger IC.

### DESCRIPTION OF THE EMBODIMENTS

Hereinafter, with reference to the accompanying drawings, a description is given of examples of an embodiment of a printing apparatus, a control method, and a storage medium. Note that the following embodiments are not intended to limit the present disclosure, and all combinations of the characteristics described in the present embodiments are not necessarily essential to the solutions provided in the present disclosure. Further, the positions, shapes, etc., of the constituent elements described in the embodiments are merely examples, and are not intended to limit the scope of this disclosure thereto.

### Printing System

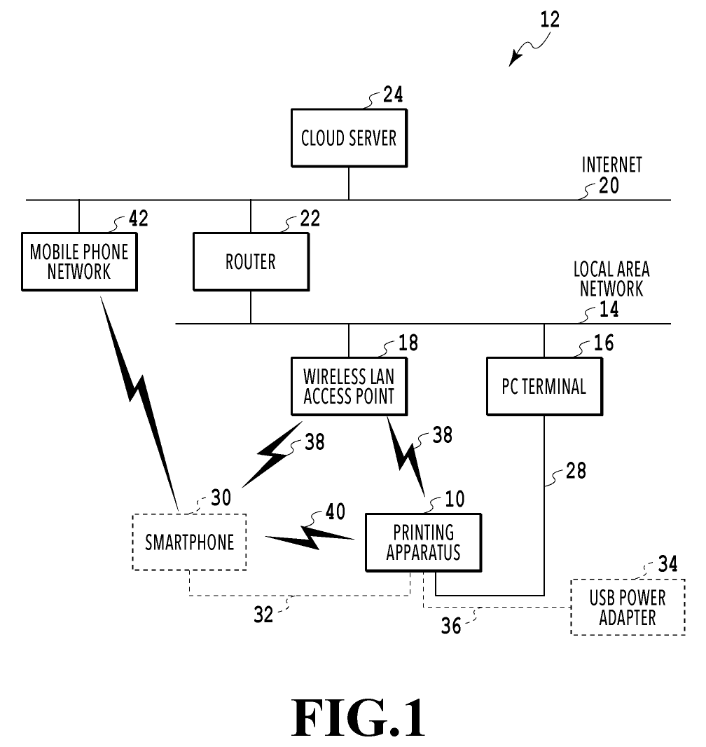

First, a description is given about a printing system including a printing apparatus according to the present embodiment. FIG. 1 is a schematic configuration diagram of the printing system including the printing apparatus according to the present embodiment.

The printing system 12 including the printing apparatus 10 according to the present embodiment includes the printing apparatus 10, which performs printing by ejecting ink, and the PC terminal 16, which serves as an external device connected to the printing apparatus 10 via the local area network 14. Note that the printing system 12 includes the wireless LAN access point 18, and the printing apparatus 10 can be connected to the local area network 14 by wirelessly connecting to the wireless LAN access point 18.

Further, the printing system 12 includes the router 22 for connecting the local area network 14 to the Internet 20, and the cloud server 24 connected to the Internet 20. Accordingly, the printing apparatus 10 and the PC terminal 16 can communicate with the cloud server 24 connected to the Internet 20 via the router 22.

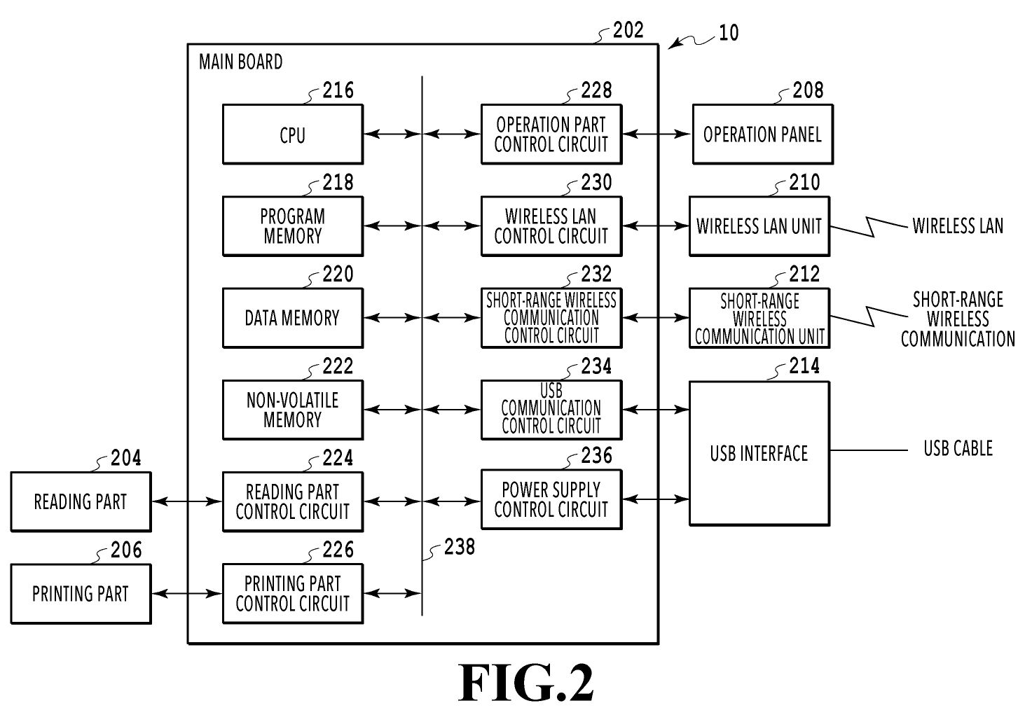

The printing apparatus 10 includes a USB (Universal Serial Bus) interface 214 (see FIG. 2) and is configured to be connectable to various devices. The USB interface 214 is configured such that a USB cable can be inserted and removed. In the present embodiment, the printing apparatus 10 is connected to the PC terminal 16 via the USB cable 28. Furthermore, the printing apparatus 10 is operable using power supplied from the PC terminal 16 via the USB cable 28.

In the printing system 12, the smartphone 30 can also be used as an external device that can serve as an external power source for the printing apparatus 10. In this case, the smartphone 30 and the printing apparatus 10 are connected via the USB cable 32, and the printing apparatus 10 can operate using power supplied from the smartphone 30. Furthermore, in the printing system 12, the printing apparatus 10 can be connected to the USB power adapter 34 via the USB cable 36. This allows the printing apparatus 10 to operate using power supplied from a commercial power source. Note that, although not illustrated in the drawings, the printing apparatus 10 can also be connected to a mobile battery via a USB cable to operate using power supplied from the mobile battery.

The wireless LAN infrastructure mode connection 38 is utilized between the smartphone 30 and the printing apparatus 10 and the wireless LAN access point 18. The printing apparatus 10 has a mode in which the printing apparatus 10 itself operates as a wireless LAN access point. At the time the printing apparatus 10 operates as an access point, the smartphone 30 can directly connect to the printing apparatus 10 (the direct connection 40). Further, via the mobile phone network 42, the smartphone 30 is capable of connecting to the cloud server 24 connected to the Internet 20.

In a case where the printing apparatus 10 and the PC terminal 16 and the smartphone 30 are connected by USB cables, data communication between the printing apparatus 10 and the PC terminal 16 and the smartphone 30 can be executed via the USB interface 214 and the USB cables. Note that data communication between the printing apparatus 10 and the PC terminal 16 and the smartphone 30 is not limited to the form in which USB cables are utilized. For example, the printing apparatus 10 may operate using power supplied from the PC terminal 16 and the smartphone 30 connected via USB cables, and data communication may be executed by utilizing a wireless LAN or short-range wireless communication.

Note that the printing system 12 illustrated in FIG. 1 is an example of the printing system including the printing apparatus 10 according to the present embodiment, and may have a configuration different from that illustrated in FIG. 1. For example, instead of the wireless LAN access point 18 and the router 22, a single configuration including these functions, such as a router with an access point function, may be used.

### Configuration of the Control System of the Printing Apparatus

Next, a description is given about the configuration of the control system of the printing apparatus 10. FIG. 2 is a block diagram illustrating the configuration of the control system of the printing apparatus 10.

The printing apparatus 10 includes the main board 202 that controls the entire printing apparatus 10, the reading part 204 that reads original documents, the printing part 206 that performs printing on print media, and the operation panel 208 that can be operated by users. Further, the printing apparatus 10 includes the wireless LAN unit 210 for connecting to a wireless LAN, the short-range wireless communication unit 212 for performing short-range wireless communication, and the USB interface 214 that can be connected to USB cables.

The main board 202 includes the CPU 216 in the form of a microprocessor, the program memory 218 in the form of a ROM, the data memory 220 in the form of a RAM, and the non-volatile memory 222 capable of retaining saved information even with no power supply. Further, the main board 202 includes the reading part control circuit 224 for controlling the reading part 204, the printing part control circuit 226 for controlling the printing part 206, and the operation part control circuit 228 for controlling the operation panel 208.

The main board 202 includes the wireless LAN control circuit 230 for controlling the wireless LAN unit 210, and the short-range wireless communication control circuit 232 for controlling the short-range wireless communication unit 212. Further, the main board 202 includes the USB communication control circuit 234 that controls the driving of the USB interface 214, and the power supply control circuit 236 that controls the amount of power supply from the USB interface 214. The configurations installed on the main board 202 are connected to each other via the internal bus 238.

The CPU 216 operates based on a control program stored in the program memory 218 and information retained in the data memory 220, using the data memory 220 as a work area. Further, the CPU 216 writes various setting values, data, etc., to the non-volatile memory 222, so that, if the power supply is cut off and then turned on again, the CPU 216 can continue to operate based on the setting values and data written in the non-volatile memory 222. As the non-volatile memory 222, for example, a semiconductor storage device such as a flash memory can be used.

The CPU 216 controls the reading part 204 via the reading part control circuit 224 to read an original document and stores the read data in the data memory 220 as image data. Further, the CPU 216 controls the printing part 206 via the printing part control circuit 226 to perform printing on a print medium based on print data obtained by performing image processing on the image data stored in the data memory 220. Furthermore, the CPU 216 controls the operation panel 208 via the operation part control circuit 228 to display a status of the printing apparatus 10 on the operation panel 208, to display a menu of selectable functions, and to accept operations from users.

The CPU 216 controls the wireless LAN unit 210 via the wireless LAN control circuit 230 to perform wireless LAN communication with other communication terminal devices. Further, the CPU 216 controls the short-range wireless communication unit 212 via the short-range wireless communication control circuit 232 to detect connections with other short-range wireless communication terminals and to transmit and receive data to and from other short-range wireless communication terminals. Furthermore, the CPU 216 operates the USB interface 214 via the USB communication control circuit 234 to perform USB communication with other terminal devices (external devices) connected via USB cables and detects whether a USB cable is inserted or removed. Moreover, the CPU 216 controls the power supply control circuit 236 to grasp and control the amount of power supply from the USB interface 214 and the amount of power stored in the power supply control circuit 236. Insertion and removal of a USB cable may be detected via the power supply control circuit 236.

### Configuration of the Power Supply System of the Printing Apparatus

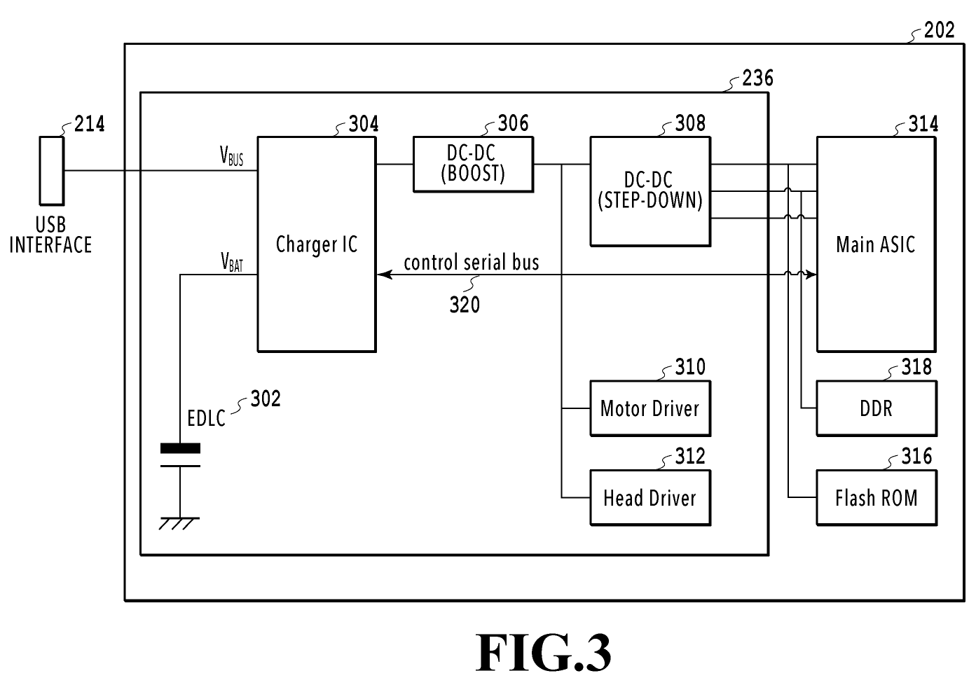

Next, an explanation is given about the configuration of the power supply system of the printing apparatus 10. FIG. 3 is a block diagram illustrating the configuration of the power supply system of the printing apparatus 10.

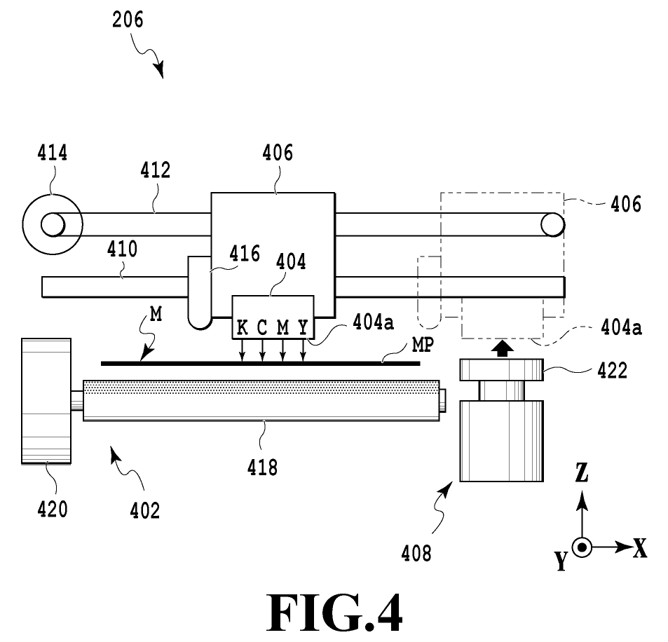

The power supply control circuit 236 includes the electric double layer capacitor (EDLC) 302 capable of storing and supplying power, and the Charger IC 304 that controls the current that has been input, etc. Further, the power supply control circuit 236 includes the DC-DC (boost) 306, which is a booster circuit for boosting the voltage from the Charger IC 304, and the DC-DC (step-down) 308, which is a step-down circuit for stepping down the voltage output from the DC-DC 306. Furthermore, the power supply control circuit 236 includes the Motor Driver 310, which drives the motors in the reading part 204 and the printing part 206, and the Head Driver 312, which drives a reading head (not illustrated in the drawings) and the print head 404 (see FIG. 4).

In the printing apparatus 10, the power supply V_{BUS} supplied from an external device via the USB interface 214 and the power supply V_{BAT} supplied from the EDLC 302 are input to the Charger IC 304. Furthermore, the printing apparatus 10 is configured to be drivable by one or both of these power supplies, and power supply control is performed by a power supply system via the Charger IC 304. That is, the printing apparatus 10 is configured to operate using power supplied from one or both of the USB interface 214 and the EDLC 302.

The Charger IC 304 controls the power supplied from the power supply V_{BUS} via the USB interface 214 to be output to the DC-DC (booster) 306 or to be used to charge the EDLC 302. Further, the Charger IC 304 controls the power supplied from the EDLC 302 to be output to the DC-DC (booster) 306. The voltage boosted by the DC-DC 306 is used by the Motor Driver 310 to drive motors of the reading part 204 and the printing part 206. Further, the voltage boosted by the DC-DC 306 is used by the Head Driver 312 to drive the reading head of the reading part 204 and the print head 404 of the printing part 206. In the power supply control circuit 236, as described above, the voltage boosted by the DC-DC 306 is used to drive a relatively large load. Thus, in the present embodiment, the DC-DC 306 functions as a supply part that supplies power to various configurations that execute processing including print processing and sheet-discharge processing. Furthermore, the power supply boosted by the DC-DC 306 is input to the DC-DC 308 to generate logic power supply voltages used by the ASIC (Main ASIC) 314, the ROM (Flash ROM) 316, and the DDR 318. Note that the ASIC 314 is a custom IC that includes the CPU 216 and its peripheral circuits.

The Charger IC 304 is an IC having functions of controlling the current input from the USB interface 214, controlling the charging and discharging of the EDLC 302, and executing protection against abnormal operations. The Charger IC 304 is capable of communicating with the ASIC 314 connected via the Control Serial Bus 320. Note that the Control Serial Bus 320 constitutes part of the internal bus 238. In the present embodiment, communication between the Charger IC 304 and the ASIC 314 is performed using the UART (Universal Asynchronous Receiver Transmitter) system.

The Charger IC 304 determines an input current in accordance with an external device (the PC terminal 16, the smartphone 30, or the like) serving as a supply source. In the present embodiment, for example, determination compliant with the USB-BC (USB Battery Charge) standard (BC determination) and determination compliant with the USB-PD (USB Power Delivery) standard (CC determination) are performed. The ASIC 314, upon receiving the results of the BC determination and the CC determination from the Charger IC 304, determines threshold values such as a charging current, a full charge, an over-discharge voltage, etc., for the Charger IC 304, and sets the threshold values in the Charger IC 304.

The EDLC 302 is an electric double layer capacitor that is subjected to charge/discharge control from the Charger IC 304 based on instructions from the ASIC 314, and supplies power to the DC-DC 306 from the power supply V_{BAT}. In the printing apparatus 10, for example, if the amount of power stored in the EDLC 302 falls below a predetermined value, the power supplied from an external device connected via the USB interface is used to charge the EDLC 302. Note that, in the present embodiment, power is supplied from the PC terminal 16, the smartphone 30, the USB power adapter 34, and a mobile battery (not illustrated in the drawings), which are connected to the printing apparatus 10 as external devices. Specifically, a voltage of the power supply V_{BAT} of the EDLC 302 can be transmitted from the Charger IC 304 to the ASIC 314. For example, if a voltage of the power supply V_{BAT} of the EDLC 302 drops during printing operation of the printing apparatus 10, the ASIC 314 stops the printing operation and instructs the Charger IC 304 to perform charging control until the voltage of the power supply V_{BAT} of the EDLC 302 reaches a certain threshold value. Then, the ASIC 314, upon receiving from the Charger IC 304 that the voltage of the power supply V_{BAT} has reached the certain threshold value, resumes the printing operation. Thus, in the present embodiment, the EDLC 302 functions as a power storage part capable of storing power supplied from an external device. Further, in the present embodiment, the ASIC 314 and the Charger IC 304 function as a control part that outputs power supplied from an external device and the EDLC 302 to the DC-DC 306 and also outputs power supplied from an external device to the EDLC 302.

### Configuration of the Printing Part

Next, a description is given about the configuration of the printing part 206 in the printing apparatus 10. Note that a description of the configuration of the reading part 204 of the printing apparatus 10 is omitted since various known technologies can be used. FIG. 4 is a schematic configuration diagram of the printing part 206.

The printing part 206 includes the conveyance part 402, which conveys the print medium M in the Y direction, and the print head 404, which performs printing by ejecting ink onto the print medium M conveyed by the conveyance part 402. Further, the printing part 206 includes the carriage 406 on which the print head 404 is mounted and which is movable in the direction (the X direction) that intersects (orthogonally, in the present embodiment) with the conveyance direction (the Y direction) of the print medium M conveyed by the conveyance part 402. Further, the printing apparatus 10 includes the maintenance part (the recovery part) 408 that is capable of executing maintenance processing (hereinafter also referred to as "recovery processing") for maintaining and recovering favorable ink ejection performance of nozzles that eject ink in the print head 404.

The print head 404 is configured to be capable of ejecting multiple types of ink that are different from each other. Multiple nozzles that eject each type of ink are arranged side by side along a direction that intersects with the X direction, thereby forming a nozzle array. In the present embodiment, the print head 404 is configured to be capable of ejecting four types of ink, namely, black (K) ink, cyan (C) ink, magenta (M) ink, and yellow (Y) ink. Note that the types and number of inks ejected from the print head 404 are not limited to those described above. Further, the print head 404 may also be configured to eject various kinds of liquids, such as a processing liquid that performs predetermined processing on ejected ink.

The carriage 406 is slidably mounted on the guide shaft 410 extending in the X direction and is connected to the carriage motor 414 via the belt 412. Accordingly, the carriage 406 is configured to be capable of reciprocating in the X direction by driving of the carriage motor 414. Therefore, the print head 404, which is mounted on the carriage 406, is configured to be capable of reciprocating in the X direction via the carriage 406.

During a printing operation, by applying driving pulses to the print head 404 while moving the carriage 406 in the X direction, ink is ejected from the print head 404 onto the print medium M, whereby printing corresponding to one scan is performed on the printing surface Mp of the print medium M. Note that the carriage 406 is equipped with the detection part 416 that is capable of detecting the printing surface Mp of the print medium M. This allows the printing apparatus 10 to detect the printing surface Mp with the detection part 416 while moving the carriage 406, whereby the results of printing by the print head 404 on the printing surface Mp can be monitored.

The conveyance part 402 includes the conveyance roller 418, which conveys the print medium M, and the conveyance motor 420, which drives the conveyance roller 418. Note that, in FIG. 4, the conveyance roller 418 and the print medium M are illustrated as being separated from each other in the Z direction for ease of understanding; however, in reality, the print medium M and the conveyance roller 418 are in contact with each other in the Z direction. In the conveyance part 402, the conveyance motor 420 is driven, whereby the print medium M is conveyed by the conveyance roller 418 in the Y direction.

During printing on the print medium M based on a job, printing operation is executed in which ink is ejected from the print head 404 onto the print medium M that has been conveyed by the conveyance part 402 to the printing start position, whereby printing corresponding to one scan is performed. Then, after executing conveyance operation in which the print medium M is conveyed by the conveyance part 402 by a predetermined amount, printing operation is performed again. In this way, in the printing apparatus 10, printing based on a job is performed on a print medium by alternately and repeatedly executing printing operation and conveyance operation.

With respect to the X direction, the maintenance part 408 is arranged within the movement area of the carriage 406 and outside the printing area in which printing on the print medium M is performed by the print head 404. The maintenance part 408 includes the cap part 422, which comes into contact with (caps) the print head 404 in order to protect the nozzle surface 404a of the print head 404. Note that, although detailed description and illustration in the drawings are omitted, the maintenance part 408 is equipped with various known maintenance members, such as a suction part which performs suctioning to create a negative pressure inside the cap part 422, a wiper part which wipes the nozzle surface 404a, and the like, for example. The nozzle surface 404a is a surface of the print head 404 that faces the printing surface Mp of the print medium M being conveyed and is a surface on which nozzles that eject ink are formed.

At the time capping is performed by the cap part 422, the print head 404 is moved to a position (the later-described standby position) at which the nozzle surface 404a faces the cap part 422 of the maintenance part 408 (see the dashed-line portion in FIG. 4), and then the cap part 422 is raised. In the present embodiment, the print head 404 stands by at the standby position at which the nozzle surface 404a faces the cap part 422 at a timing where printing operation is not performed or the like. By performing capping after printing based on a job ends, it is possible to protect the nozzle surface 404a and suppress evaporation of liquid components of ink from the nozzles and thickening of the ink in the nozzles due to such evaporation. Note that, even though such capping is performed, ejection performance of ink from the nozzles deteriorates. Therefore, for example, based on input from the user via the operation panel 208, the maintenance part 408 executes maintenance processing for maintaining and recovering favorable ejection performance. In the present embodiment, the configuration is such that the cap part 422 is included in the maintenance part 408; however, there is no such limitation, and the cap part 422 may be installed separately from a maintenance part that includes a suction part, a wiper part, and the like.

### Concerns Arising from Known Technologies

Meanwhile, in the printing apparatus 10, in print processing for executing printing based on a job, once the last print medium is discharged, there is a high possibility that the user determines that the print processing has ended, and unplugs a USB cable from at least one of the printing apparatus 10 and an external device. If a USB cable is unplugged at this timing, maintenance processing after the print processing is not executed, which may result in deterioration of ejection performance of the print head. Therefore, with a known technology in which charging of the EDLC 302 is simply performed before execution of a sequence, charging cannot be performed after print processing, and maintenance processing cannot be executed. Thus, in such a case, for example, it is conceivable that an amount of power at least capable of executing maintenance processing is to be stored before discharging the last print medium, which is easily recognized by a user.

Further, if the user unintentionally unplugs the USB cable during print processing, the printing apparatus 10 is stopped at that point, and the maintenance processing is not executed. This may result in deterioration in ejection performance of the print head. Also in this case, with a known technology in which charging of the EDLC 302 is simply performed before executing a sequence, the power for executing the maintenance processing cannot be secured, and thus the maintenance processing cannot be executed. Therefore, in such a case, for example, it is conceivable to store, before executing print processing, an amount of power at least capable of executing the print processing and the maintenance processing.

Hereinafter, a description is given about the control processing executed in a case where the power capable of executing the maintenance processing is stored before the last print medium is discharged. In the description of the present embodiment, the maintenance processing is capping of the nozzle surface 404a by the cap part 422.

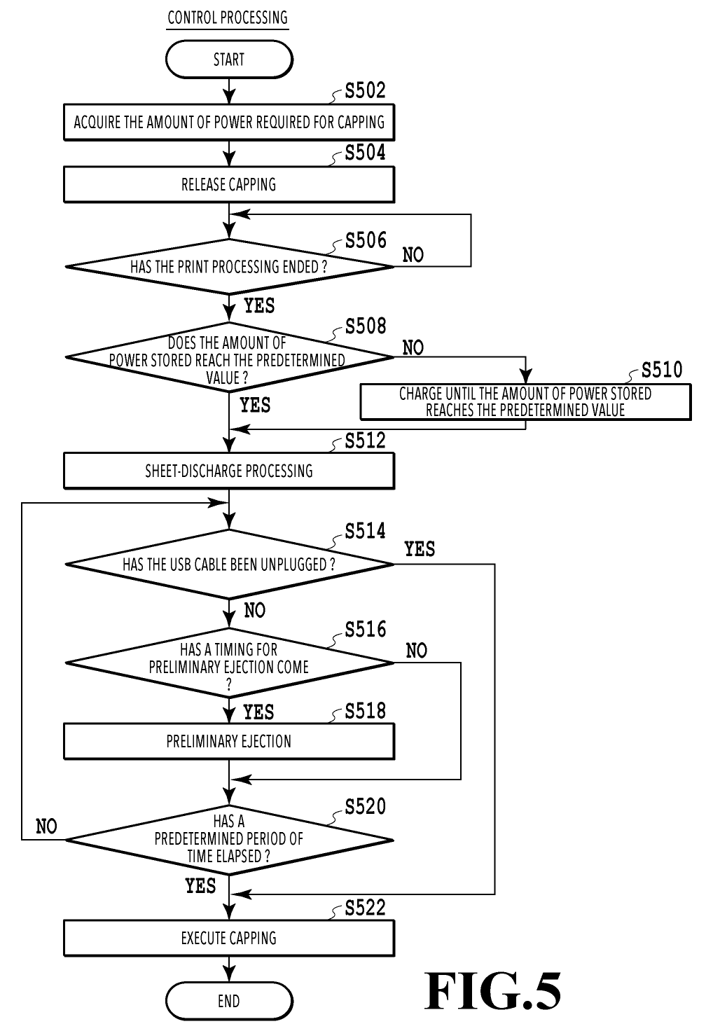

FIG. 5 is a flowchart illustrating details of processing of the control processing that controls charging of the EDLC 302 and the maintenance processing on the print head 404 so that the power capable of executing the maintenance processing is stored before the last print medium is discharged. In the present specification, the sign "S" in the description of each process in the flowchart indicates that it is a step in the flowchart.

Note that the control processing of FIG. 5 is executed in parallel with print processing based on a job. If the control processing is started, first, in S502, the CPU 216 acquires the power required for capping from the non-volatile memory 222. Then, in S504, the CPU 216 releases the capping of the print head 404 by the cap part 422. Note that the print processing executed in parallel with the control processing is started after the capping of the print head 404 is released in the control processing.

Next, in S506, the CPU 216 determines whether or not the print processing has ended. Note that, in S506, it is determined that the print processing has ended at the timing where printing on the last print medium in the print processing is completed. Further, in the print processing, for example, conveyance of print media is stopped at the timing where printing on the last print medium is completed. That is, if it is determined in S506 that the print processing has ended, the print medium remains inside the printing apparatus 10.

If it is determined in S506 that the print processing has ended, the processing proceeds to S508, where the CPU 216 determines whether or not the amount of power stored in the EDLC 302 reaches a predetermined value. The predetermined value is a value corresponding to the amount of power required for capping, which is acquired in S502. The amount of power stored in the EDLC 302 is acquired based on, for example, a voltage of the power supply V_{BAT} of the EDLC 302 at the Charger IC 304.

If it is determined in S508 that the amount of power stored in the EDLC 302 reaches the predetermined value, the processing proceeds to S512, which is described later. Further, if it is determined in S508 that the amount of power stored in the EDLC 302 does not reach the predetermined value, the processing proceeds to S510, and the CPU 216 charges the EDLC 302 until the amount of power stored in the EDLC 302 reaches the above-described predetermined value. Thereafter, the processing proceeds to S512, where the CPU 216 executes the sheet-discharge processing that conveys the print medium remaining inside the printing apparatus.

Next, in S514, the CPU 216 determines whether or not the USB cable has been unplugged. If it is determined in S514 that the USB cable has been unplugged, the processing proceeds to S522, which is described later. Further, if it is determined in S514 that the USB cable has not been unplugged, the processing proceeds to S516, where the CPU 216 determines whether or not a timing has come to execute preliminary ejection, which is ejection of ink that does not contribute to printing at each nozzle. In the present embodiment, the preliminary ejection is performed at intervals of 30 seconds. Note that, after the sheet-discharge processing is completed in S512, the CPU 216 starts counting time, so that determination in S516 is performed based on this count value.

If it is determined in S516 that a timing to perform preliminary ejection has not come, the processing proceeds to S520, which is described later. Further, if it is determined in S516 that a timing to perform preliminary ejection has come, the processing proceeds to S518, where the CPU 216 executes preliminary ejection. The print head 404 is moved to the standby position after the print processing ends. Therefore, preliminary ejection of ink is performed into the cap part 422 located at a position facing the nozzle surface 404a.

Thereafter, in S520, the CPU 216 determines whether or not a predetermined period of time (for example, 10 minutes) has elapsed. If it is determined in S520 that the predetermined period of time has not elapsed, the processing returns to S514. Further, if it is determined in S520 that the predetermined period of time has elapsed, the processing proceeds to S522, where the CPU 216 executes capping of the print head 404 at the standby position by the cap part 422, thereby ending this control processing.

In this control processing, before executing the sheet-discharge processing, an amount of power corresponding to the amount of power required for capping (the maintenance processing) is charged. Therefore, at the time of execution of S522, the amount of power required for capping is at least stored in the EDLC 302. Therefore, in S522, capping can be reliably executed using the power stored in the EDLC 302.

Note that, in a case of storing an amount of power capable of executing the print processing and the maintenance processing (capping) before executing the print processing, in S502, the amount of power required for the print processing and the amount of power required for capping are acquired. Then, after the capping is released in S504, whether or not the amount of power stored in the EDLC 302 has reached a predetermined value corresponding to the sum of the two amounts of power acquired in S502 is determined, and, if it is determined that the predetermined value has been reached, the start of print processing is permitted. Further, if it is determined that the predetermined value has not been reached, the start of print processing is permitted after the amount of power stored in the EDLC 302 reaches the predetermined value. The print processing is started based on the permission. Thereafter, the processing proceeds to S506, and, if it is determined that the print processing has ended, the processing proceeds to S512 without passing through S508 and S510, so as to execute the processes in and after S512.

In this way, in the case of the above-described technology, the time period for charging the EDLC 302 is independently set, apart from processing operations of the printing apparatus 10. This increases the total period of time required for printing in the printing apparatus 10, and further, the charging time is downtime for the user.

### Control Processing According to the Present Embodiment

Therefore, in the present embodiment, in order to suppress an increase in a total period of time required for printing in the printing apparatus 10, charging of the EDLC 302 is executed even during processing operations of the printing apparatus 10. Hereinafter, a detailed description is given about the control processing executed in the printing apparatus 10 according to the present embodiment.

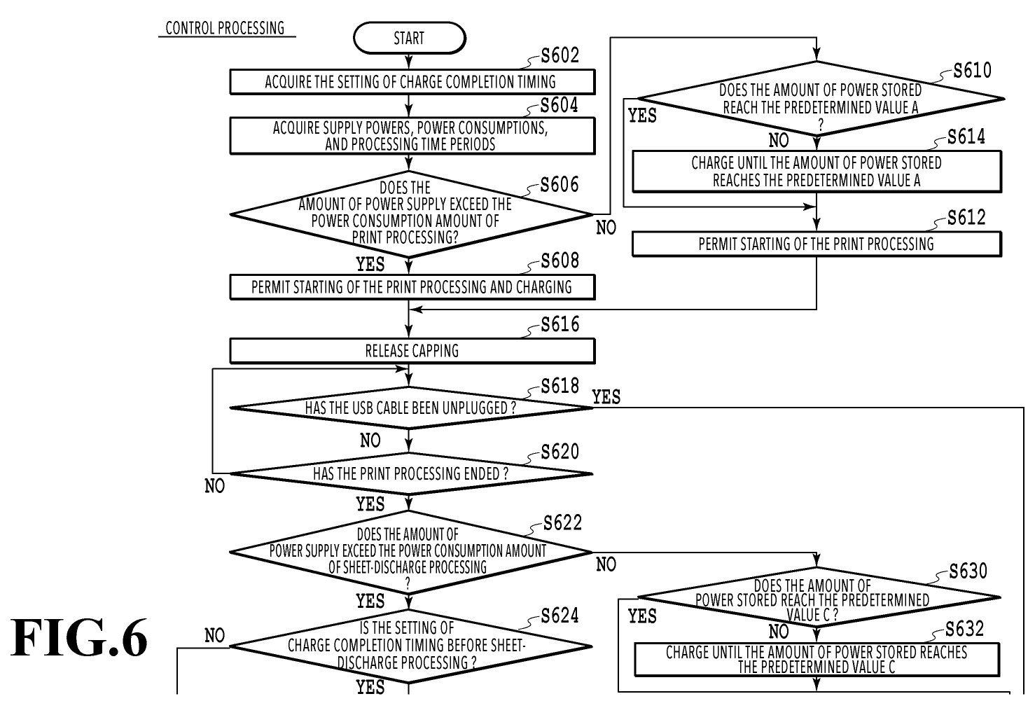

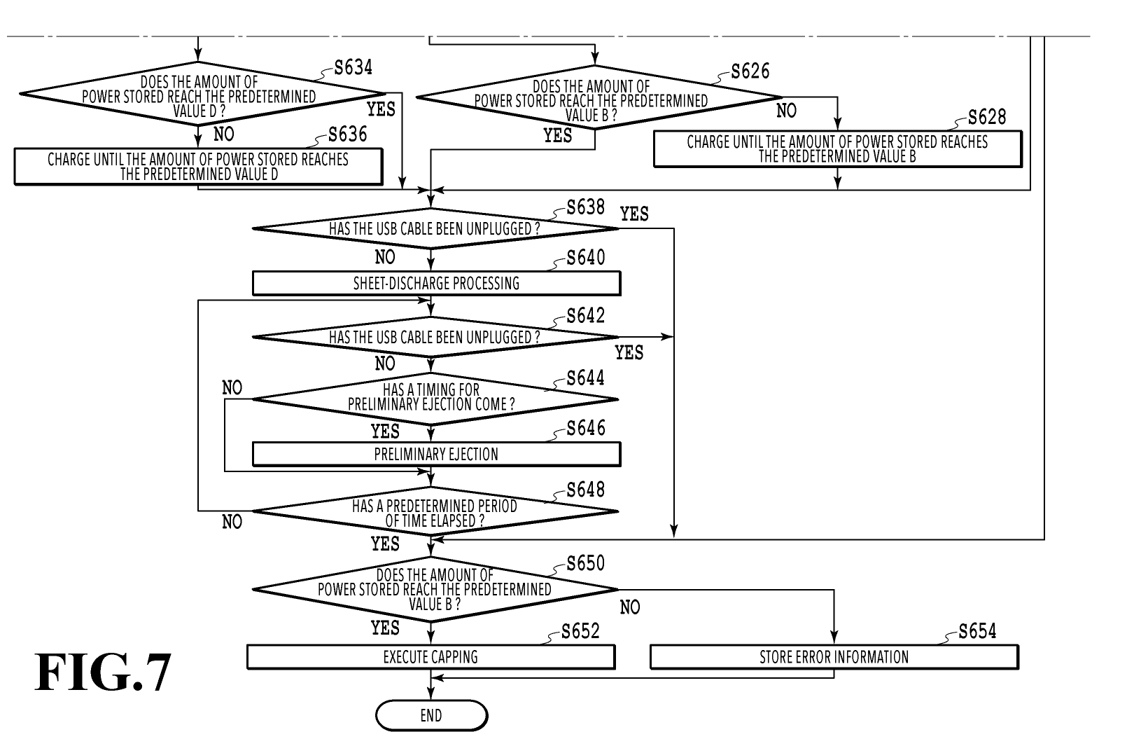

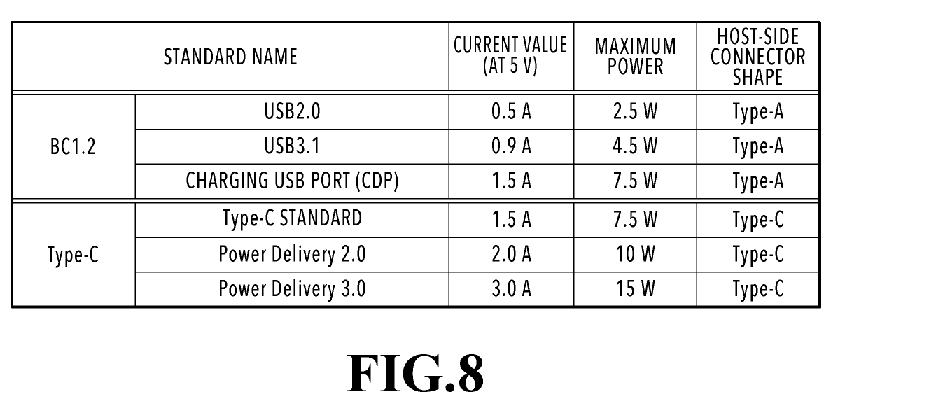

FIGS. 6 and 7 are flowcharts illustrating the details of processing of the control processing that is executed in the printing apparatus 10 according to the present embodiment and that controls charging of the EDLC 302 as well as the maintenance processing performed on the print head 404. FIG. 8 is a table illustrating amounts of power supply for each connection standard. The series of processes illustrated in the flowchart of FIGS. 6 and 7 is performed by the CPU 216 loading a program code stored in the program memory 218 into the data memory 220 and executing it. Alternatively, part or all of the functions in the steps of FIGS. 6 and 7 may be executed by hardware such as an ASIC or an electronic circuit.

In the printing apparatus 10, in a case where an instruction to start the print processing is given, the control processing is started. In a case where the control processing is started, first, in S602, the CPU 216 acquires the setting of charge completion timing. The setting of charge completion timing is a setting value for setting a timing at which charging of the EDLC 302 is completed. As timings that can be set as the charge completion timing, for example, a timing before sheet-discharge processing, which is immediately before sheet-discharge processing is executed, and a timing after sheet-discharge processing, which is immediately after sheet-discharge processing ends, can be set. The charge completion timing is not limited to these two timings, and may be settable to any desired timing such as T seconds after print processing is started or at a P-th scan (a scan involving printing) during print processing. Alternatively, the setting may be uniquely determined depending on a state of the printing apparatus 10, a usage environment thereof, or the like. Further, the setting of charge completion timing can be set by a user via the operation panel 208 or the like. By the setting of charge completion timing, charging of the EDLC 302 to an amount of power at least capable of executing the maintenance processing (capping) is controlled so as to be completed by that timing.

Next, in S604, the CPU 216 acquires the maximum supply power Psp of the external device, the power consumption amount Pp of the print processing, the power consumption amount Pd of the sheet-discharge processing, and the power consumption amount Pm of the maintenance processing. Further, in S604, the time period Tp required for the print processing, the time period Td required for the sheet-discharge processing, and the time period Tm required for the maintenance processing (capping, in the present embodiment) are acquired. The maximum supply power Psp of the external device is the maximum power of the USB used for connection to the external device. The power consumption amount Pp of the print processing is an amount of power consumed in the print processing. The power consumption amount Pd of the sheet-discharge processing is an amount of power consumed in the sheet-discharge processing in S640, which is described later. The power consumption amount Pm of the maintenance processing is an amount of power consumed in capping in S652, which is described later.

The non-volatile memory 222 stores, for example, a table indicating amounts of power supply for each connection standard (see FIG. 8). Therefore, the maximum supply power Psp of the external device is calculated based on the detected USB standard and the table indicating amounts of power supply for each connection standard, which is stored in the non-volatile memory 222. Further, as for the power consumption amount Pp of the print processing, for example, calculation is performed based on setting contents of an input job and print data.

As for the power consumption amount Pd of the sheet-discharge processing, for example, calculation is performed based on the type of print medium, in accordance with a stored calculation formula or the like. Alternatively, a table (not illustrated in the drawings) in which a power consumption amount per sheet during the sheet-discharge processing is set for each type of print medium may be stored in the non-volatile memory 222, so that the power consumption amount Pd of the sheet-discharge processing is calculated by referring to that table. Further, the non-volatile memory 222 retains the power consumption amount required during capping. Therefore, in the present embodiment, as for the power consumption amount Pm of the maintenance processing, the power consumption amount during capping, which is retained in the non-volatile memory 222, is acquired.

Thereafter, in S606, the CPU 216 determines whether or not the amount of power supply from the external device during the print processing exceeds the power consumption amount Pp of the print processing. That is, in S606, whether or not the amount of power supplied from the external device exceeds the amount of power consumed in the print processing is determined. Specifically, in S606, first, an amount of power supply from the external device is acquired based on the maximum supply power Psp of the external device acquired in S604 and the time period Tp required for the print processing acquired in S604, and then whether or not this value exceeds the power consumption amount Pp of the print processing is determined.

If it is determined in S606 that the amount of power supply from the external device during the print processing exceeds the power consumption amount Pp of the print processing, the processing proceeds to S608, where the CPU 216 permits start of the print processing and start of charging of the EDLC 302, and then the processing proceeds to S616, which is described later. Further, if it is determined in S606 that the amount of power supply from the external device during the print processing does not exceed the power consumption amount Pp of the print processing, that is, is equal to or less than the power consumption amount Pp of the print processing, the processing proceeds to S610. In S610, the CPU 216 determines whether or not the amount of power stored in the EDLC 302 reaches the predetermined value A. In the present embodiment, the predetermined value A is, for example, a value obtained by subtracting the amount of power supply from the external device during the print processing, which is acquired in S606, from the power consumption amount Pp of the print processing.

Note that the predetermined value A may be a value obtained by adding a predetermined amount of power to the above-described value. The predetermined amount of power is, for example, a value obtained by summing an amount of power lacking during the sheet-discharge processing in S640, which is described later, and an amount of power lacking during preliminary ejection in S642 to S648, which is executed after the sheet-discharge processing. The above-mentioned amount of power lacking during the sheet-discharge processing is, for example, an amount of power obtained by subtracting an amount of power supply from the external device during the sheet-discharge processing (which is calculated from the maximum supply power Psp of the external device and the time period required for the sheet-discharge processing) from the power consumption amount Pd of the sheet-discharge processing. Further, the above-mentioned amount of power lacking during preliminary ejection is, for example, an amount of power obtained by subtracting, from an amount of power consumed by the preliminary ejection (S646) executed within a predetermined time period (corresponding to the predetermined period of time in S648, which is described later), an amount of power calculated from the predetermined time period and the maximum supply power Psp of the external device. The amount of power consumed by the preliminary ejection executed within the predetermined time period is, for example, stored in the non-volatile memory 222.

If it is determined in S610 that the amount of power stored in the EDLC 302 reaches the predetermined value A, the processing proceeds to S612, where the CPU 216 permits start of the print processing. Further, if it is determined in S610 that the amount of power stored in the EDLC 302 does not reach the predetermined value A, the processing proceeds to S614, where the CPU 216 charges the EDLC 302 until the amount of power stored reaches the predetermined value A, and then the processing proceeds to S612.

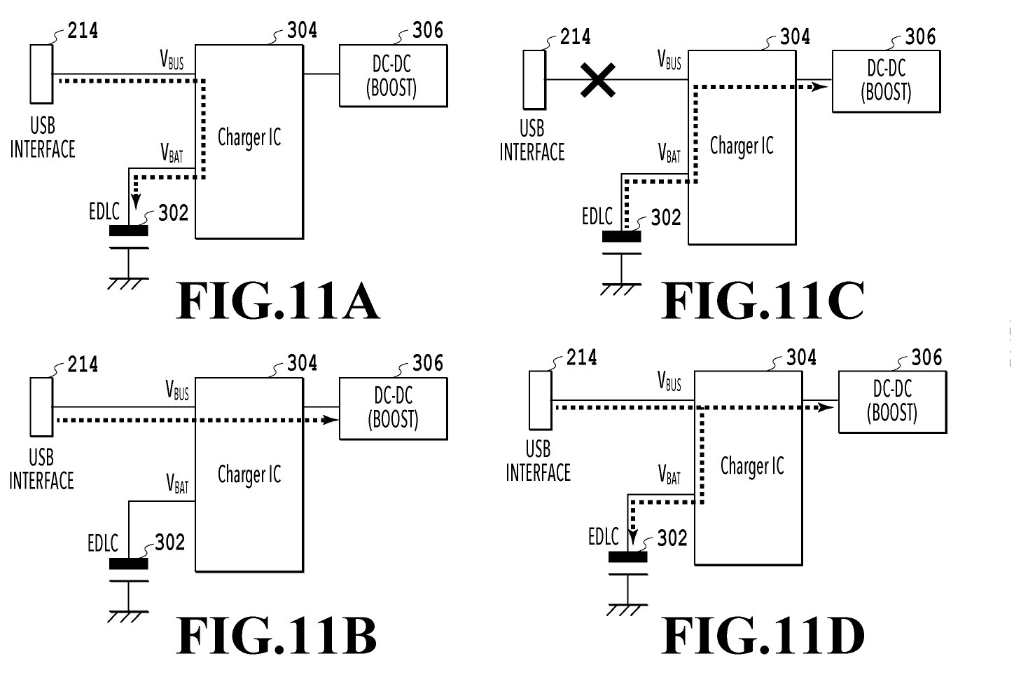

In S616, the CPU 216 releases capping of the print head 404 by the cap part 422. That is, the cap part 422 is separated from the print head 404. In the present embodiment, the print processing, which is executed in parallel with the control processing, is started once the releasing of capping is executed by the control processing. Note that, in a case where permission to start charging of the EDLC 302 is given in S608 together with permission to start the print processing, charging of the EDLC 302 is also started at the time the print processing is started. That is, at this time, the power supply V_{BUS} supplied from the external device via the USB interface 214 is output to the DC-DC 306 by the Charger IC 304 and is also used to charge the EDLC 302 (see FIG. 11D). More specifically, the surplus power that is output to the DC-DC 306 but is not required for processing operations is used to charge the EDLC 302. Further, in a case where only permission to start the print processing is given in S612, only the print processing is started without executing charging of the EDLC 302. That is, at this time, the power supply V_{BUS} supplied from the external device via the USB interface 214 is output only to the DC-DC 306 (see FIG. 11D).

Next, in S618, the CPU 216 determines whether or not the USB cable has been unplugged. In the present specification, "the USB cable has been unplugged" includes a case where the USB cable is unplugged from the printing apparatus 10 and a case where the USB cable connected to the printing apparatus 10 is unplugged from an external device. That is, "the USB cable has been unplugged" refers to a case where, due to the USB cable being unplugged, supply of power from an external device to the printing apparatus 10 is stopped. Note that "the USB cable has been unplugged" may also include a case where supply of power to the printing apparatus 10 from an external device connected by a USB cable is stopped.

Therefore, in S618, for example, whether or not the USB cable for supplying power has been unplugged from the USB interface 214 is determined via the USB communication control circuit 234 or the power supply control circuit 236. Further, in S618, for example, the CPU 216 checks a state of input current control in the Charger IC 304 and determines whether or not the EDLC 302 is currently receiving supply of power from the external device. Therefore, in the printing system 12, in a case where power is supplied to the printing apparatus 10 from the USB power adapter 34 via the USB cable 36, then in S618, whether or not the USB cable 36 has been unplugged from the USB interface 214 is determined.

If it is determined in S618 that the USB cable has been unplugged, the processing proceeds to S650, which is described later. Further, if it is determined in S618 that the USB cable has not been unplugged, the processing proceeds to S620, where the CPU 216 determines whether or not the print processing has ended. Note that the CPU 216 determines that the print processing has ended at the timing where printing on the last print medium in the print processing is completed. Further, in the print processing, for example, conveyance of print media is stopped at the timing where printing on the last print medium is completed. That is, if it is determined in S620 that the print processing has ended, the print medium remains inside the printing apparatus 10.

If it is determined in S620 that the print processing has not ended, the processing returns to S618. Further, if it is determined in S620 that the print processing has ended, the processing proceeds to S622, where the CPU 216 determines whether or not an amount of power supply from the external device during the sheet-discharge processing exceeds the power consumption amount Pd of the sheet-discharge processing. That is, in S620, whether or not an amount of power supplied from the external device during the sheet-discharge processing exceeds an amount of power consumed in the sheet-discharge processing is determined. Specifically, in S620, whether or not a value calculated from the maximum supply power Psp of the external device and the time period Td required for the sheet-discharge processing, which are acquired in S604, exceeds the power consumption amount Pd of the sheet-discharge processing is determined.

In S622, if it is determined that the amount of power supply from the external device during the sheet-discharge processing exceeds the power consumption amount Pd of the sheet-discharge processing, the processing proceeds to S624, where the CPU 216 determines whether or not the setting of charge completion timing, which is acquired in S602, is before sheet-discharge processing. In S624, if it is determined that the setting of charge completion timing is before sheet-discharge processing, the processing proceeds to S626, where the CPU 216 determines whether or not the amount of power stored in the EDLC 302 reaches the predetermined value B. In the present embodiment, the predetermined value B is the power consumption amount Pm of the maintenance operation.

Note that the predetermined value B may be a value obtained by adding a predetermined amount of power to the power consumption amount Pm of the maintenance operation. The predetermined amount of power is, for example, an amount of power lacking during preliminary ejection, which is executed in S642 to S648 after the sheet-discharge processing. The herein-mentioned amount of power lacking during preliminary ejection is, for example, an amount of power obtained by subtracting, from an amount of power consumed by the preliminary ejection (S646) executed within a predetermined time period (corresponding to the predetermined period of time in S648, which is described later), an amount of power calculated from the predetermined time period and the maximum supply power Psp of the external device.

If it is determined in S626 that the amount of power stored in the EDLC 302 reaches the predetermined value B, the processing proceeds to S638, which is described later. Further, if it is determined in S626 that the amount of power stored in the EDLC 302 does not reach the predetermined value B, the processing proceeds to S628, where the CPU 216 charges the EDLC 302 until the amount of power stored reaches the predetermined value B, and then the processing proceeds to S638, which is described later.

Further, if it is determined in S622 that the amount of power supply from the external device during the sheet-discharge processing does not exceed the power consumption amount Pd of the sheet-discharge processing, that is, is equal to or less than the power consumption amount Pd of the sheet-discharge processing, the processing proceeds to S630. In S630, the CPU 216 determines whether or not the amount of power stored in the EDLC 302 reaches the predetermined value C. In the present embodiment, the predetermined value C is, for example, a value obtained by adding the power consumption amount Pm of the maintenance processing to a value obtained by subtracting, from the power consumption amount Pd of the sheet-discharge processing, an amount of power supply from the external device during the sheet-discharge processing, which is calculated from the maximum supply power Psp of the external device and the time period Td required for the sheet-discharge processing. That is, the predetermined value C is a summed value of an amount of power lacking during the sheet-discharge processing even in a case where charging is performed during the sheet-discharge processing and an amount of power required to execute the maintenance processing.

Note that the predetermined value C may be a value obtained by adding a predetermined amount of power to the above-described value. The predetermined amount of power is, for example, an amount of power lacking during preliminary ejection, which is executed in S642 to S648 after the sheet-discharge processing. The herein-mentioned amount of power lacking during preliminary ejection is, for example, an amount of power obtained by subtracting, from an amount of power consumed by the preliminary ejection (S646) executed within a predetermined time period (corresponding to the predetermined period of time in S648, which is described later), an amount of power calculated from the predetermined time period and the maximum supply power Psp of the external device.

If it is determined in S630 that the amount of power stored in the EDLC 302 reaches the predetermined value C, the processing proceeds to S638, which is described later. Further, if it is determined in S630 that the amount of power stored in the EDLC 302 does not reach the predetermined value C, the processing proceeds to S632, where the CPU 216 charges the EDLC 302 until the amount of power stored reaches the above-described predetermined value C, and then the processing proceeds to S638, which is described later.

Further, in S624, if it is determined that the setting of charge completion timing is not before sheet-discharge processing, that is, is after sheet-discharge processing, the processing proceeds to S634, where the CPU 216 determines whether or not the amount of power stored in the EDLC 302 reaches the predetermined value D. In the present embodiment, the predetermined value D is, for example, a value obtained by subtracting, from the power consumption amount Pm of the maintenance processing, a value obtained by subtracting an amount of power supply from the external device during the sheet-discharge processing, which is calculated from the maximum supply power Psp of the external device and the time period Td required for the sheet-discharge processing. That is, in a case where this processing path is taken, since charging is performed even during the sheet-discharge processing, the predetermined value D is a value obtained by subtracting an amount of power charged during the sheet-discharge processing from the power consumption amount Pm of the maintenance processing.

Note that the predetermined value D may be a value obtained by adding a predetermined amount of power to the above-described value. The predetermined amount of power is, for example, an amount of power lacking during preliminary ejection, which is executed in S642 to S648 after the sheet-discharge processing. The herein-mentioned amount of power lacking during preliminary ejection is, for example, an amount of power obtained by subtracting, from an amount of power consumed by the preliminary ejection (S646) executed within a predetermined time period (corresponding to the predetermined period of time in S648, which is described later), an amount of power calculated from the predetermined time period and the maximum supply power Psp of the external device.

If it is determined in 634 that the amount of power stored in the EDLC 302 reaches the predetermined value D, the processing proceeds to S638, which is described later. Further, if it is determined in S634 that the amount of power stored in the EDLC 302 does not reach the predetermined value D, the processing proceeds to S636, where the CPU 216 charges the EDLC 302 until the amount of power stored reaches the predetermined value D, and then the processing proceeds to S638, which is described later.

In S638, the CPU 216 determines whether or not the USB cable has been unplugged. Since the specific details of processing of S638 are the same as those of S618 described above, the detailed description thereof is omitted. If it is determined in S638 that the USB cable has been unplugged, the processing proceeds to S650, which is described later. Further, if it is determined in S638 that the USB cable has not been unplugged, the processing proceeds to S640, where the CPU 216 executes the sheet-discharge processing for discharging the print medium that remains inside the printing apparatus 10 after printing.

Thereafter, in S642, the CPU 216 determines whether or not the USB cable has been unplugged. Since the specific details of processing of S642 are the same as those of S618 described above, the detailed description thereof is omitted. If it is determined in S642 that the USB cable has been unplugged, the processing proceeds to S650, which is described later. Further, if it is determined in S642 that the USB cable has not been unplugged, the processing proceeds to S644, where the CPU 216 determines whether or not a timing to execute preliminary ejection has come. In the present embodiment, the preliminary ejection is executed at intervals of a predetermined time period after the sheet-discharge processing in S640, for example, at intervals of 30 seconds. Therefore, in S644, at the first determination after the control processing is started, whether or not the predetermined time period has elapsed since completion of the sheet-discharge processing is determined, and in S644, at the second and subsequent determinations after the control processing is started, whether or not the predetermined time period has elapsed since the previous preliminary ejection is determined. Note that, after the sheet-discharge processing is completed in S640, the CPU 216 starts counting time, so that determination in S644 is performed based on this count value.

If it is determined in S644 that a timing to perform preliminary ejection has not come, the processing proceeds to S648, which is described later. Further, if it is determined in S644 that a timing for preliminary ejection has come, the processing proceeds to S646, where the CPU 216 executes preliminary ejection, and then the processing proceeds to S648, which is described later. The print head 404 has been moved to the standby position after the print processing ends, where the nozzle surface 404a faces the cap part 422. Therefore, preliminary ejection of ink is performed into the cap part 422.

In S648, the CPU 216 determines whether or not a predetermined period of time has elapsed. In the present embodiment, for example, whether or not a predetermined period of time has elapsed since the sheet-discharge processing is completed in S640 is determined. Therefore, in S648, whether or not a count value that starts being counted in accordance with the processing in S640 has reached a predetermined period of time is determined. The predetermined period of time is, for example, 10 minutes, and may be appropriately changeable.

If it is determined in S648 that the predetermined period of time has not elapsed, the processing returns to S642. Further, if it is determined in S648 that the predetermined period of time has elapsed, the processing proceeds to S650. In S650, the CPU 216 determines whether or not the amount of power stored in the EDLC 302 reaches the predetermined value B. Since the specific details of processing of S650 are the same as those of S626 described above, the detailed description thereof is omitted.

If it is determined in S650 that the amount of power stored in the EDLC 302 reaches the predetermined value B, the processing proceeds to S652, where the CPU 216 executes capping of the print head 404 at the standby position by the cap part 422, thereby ending this control processing. Further, if it is determined in S650 that the amount of power stored in EDLC 302 does not reach the predetermined value B, it is determined that an error has occurred in the charging function for the EDLC 302 or the like, and information related to this error is stored in non-volatile memory 222, thereby ending this control processing.

In the printing apparatus 10, for example, to terminate the control processing, the power may be turned off. In this case, if there is any process that needs to be performed at the time the power is turned off, the process is executed, and then the power is turned off. Further, in this case, if the control processing is terminated after the information related to an error is stored, the power-off information that indicates that the power is turned off due to occurrence of an error is stored in a storage area such as the non-volatile memory 222. Further, in the printing apparatus 10, at the time where the power is turned on, if the power-off information is retained in a storage area and power is supplied from an external device, the predetermined maintenance processing is executed, and thereafter, the power-off information stored in the storage area is deleted. In the control processing described above, there are three timings to detect whether the USB cable is unplugged; however, it is also possible to constantly detect, from the start to the end of the control processing, whether the USB cable is unplugged.

### About the Time Period Required for Printing

Next, a description is given about a time period required for printing in the printing apparatus 10. In this specification, the time period required for printing refers to the time period required to execute the print processing based on a job, the sheet-discharge processing for the last print medium, and the maintenance processing after the print processing, and includes the charging time period for charging the power required to execute the processing.

In the following description, Comparative Examples 1 and 2 and an exemplary embodiment are described. Comparative Example 1 is a time period required for printing in a case where the control processing described with reference to FIG. 5, in which an amount of power capable of executing maintenance processing is charged after print processing, is performed. Comparative Example 2 is a time period required for printing in a case where the above-described control processing in which an amount of power capable of executing print processing and maintenance processing is charged before the print processing is performed. The exemplary embodiment is a time period required for printing in a case where the control processing described with reference to FIGS. 6 and 7, which is executed in the printing apparatus 10 according to the present embodiment, is performed.

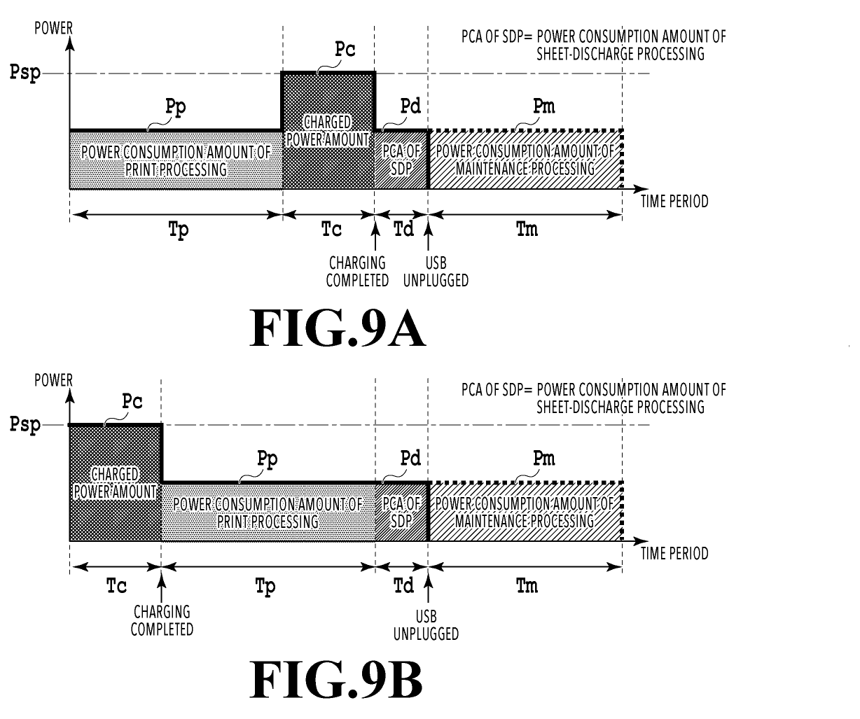

FIGS. 9A and 9B are diagrams each illustrating a relationship between power consumption amounts and a charged power amount and time periods corresponding to the respective processing included in the time period required for printing in the printing apparatus 10, wherein FIG. 9A illustrates Comparative Example 1, and FIG. 9B illustrates Comparative Example 2.

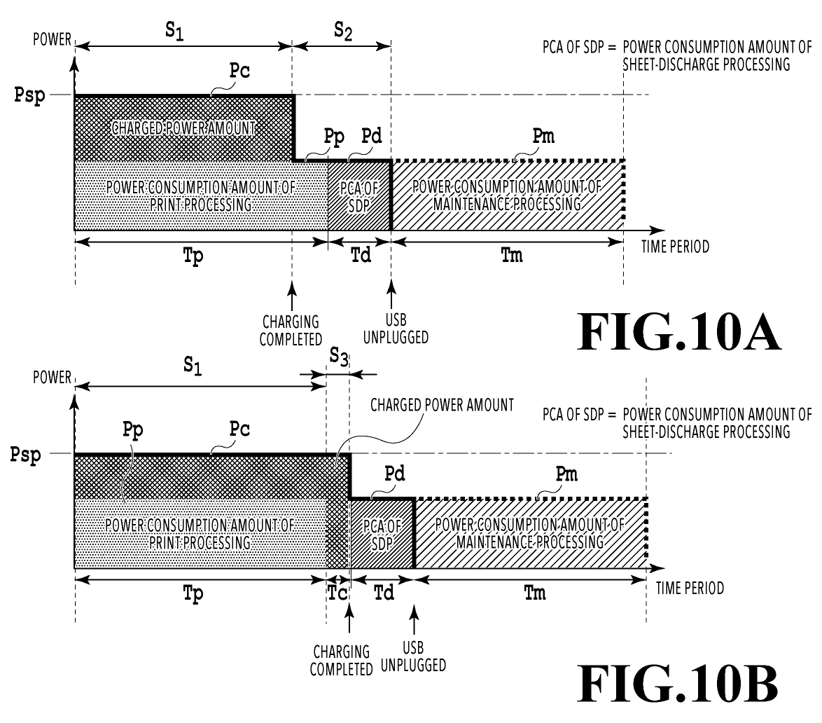

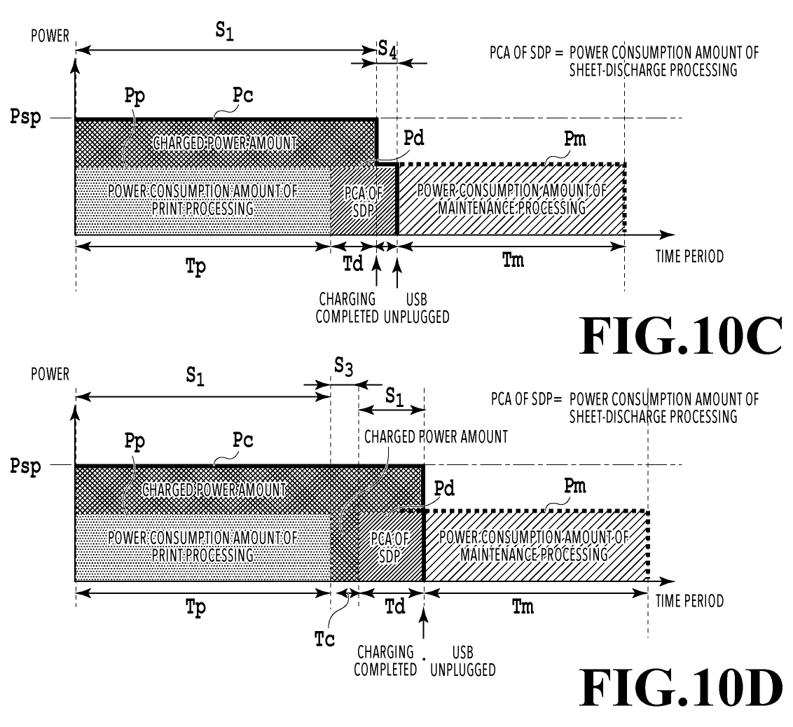

FIGS. 10A to 10D are diagrams each illustrating a relationship, in an exemplary embodiment, between power consumption amounts and a charged power amount and time periods corresponding to respective processing included in the time period required for printing in the printing apparatus 10. FIG. 10A illustrates a case in which an amount of power capable of executing maintenance processing during print processing is charged. FIG. 10B illustrates a case in which the setting of charge completion timing is before sheet-discharge processing, whereby a time period during which only charging is performed occurs before sheet-discharge processing. FIG. 10C illustrates a case in which the setting of charge completion timing is after sheet-discharge processing, whereby an amount of power capable of executing maintenance processing is charged during sheet-discharge processing. FIG. 10D illustrates a case in which the charge completion timing is after sheet-discharge processing, wherein a time period during which only charging is performed occurs before sheet-discharge processing.

FIGS. 11A to 11D are diagrams each illustrating a flow of current among the USB interface 214, the EDLC 302, and the DC-DC 308, which are controlled by the Charger IC. FIG. 11A illustrates a flow of current in a case where the EDLC 302 is charged by the power supply V_{BUS} supplied from an external apparatus. FIG. 11B illustrates a flow of current in a case where the power supply V_{BUS} is output to the DC-DC 306. FIG. 11C illustrates a flow of current in a case where the power supply V_{BAT} from the EDLC 302 is output to the DC-DC 306. FIG. 11D illustrates a flow of current in a case where the EDLC 302 is charged while the power supply V_{BUS} is output to the DC-DC 306.

Note that, for comparison, FIGS. 9A to 10D each illustrate a case in which the maximum supply power Psp of the external device is capable of sufficiently supplying the power consumption amount Pp of the print processing, the power consumption amount Pd of the sheet-discharge processing, and the power consumption amount Pm of the maintenance processing. Note that FIGS. 10A to 10D each illustrate an example of a relationship between power consumption amounts and a charged power amount and time periods corresponding to respective processing included in the time period required for printing. In each of the illustrated cases, particularly in S606, the power supply amount from the external device during print processing exceeds the power consumption amount Pp of the print processing, and, in S622, the power supply amount from the external device during sheet-discharge processing exceeds the power consumption amount Pd of the sheet-discharge processing.

The maximum supply power Psp of the external device indicates a maximum supply power of the power supply V_{BUS}, which is supplied from the external device connected via the USB interface 214. The maximum supply power varies depending on the external device serving as a supply source and can be determined by the Charger IC 304. The power consumption amount Pp of the print processing indicates a power consumption amount required for the print processing and is a total amount of power output by the Charger IC 304 to the DC-DC 306 during the print processing. Further, the power consumption amount Pp of the print processing varies depending on all factors relating to the print processing, such as a job, the carriage motor 414, and the time period Tp required for the print processing.

The charged power amount Pc is a total amount of power charged to the EDLC 302. For example, in FIG. 9A, the charged power amount Pc is an amount of power obtained by adding a predetermined amount of power to the amount of power required for capping. Further, in FIG. 9B, the charged power amount Pc is an amount of power obtained by adding a predetermined amount of power to the amount of power required for capping and print processing. The power consumption amount Pd of the sheet-discharge processing indicates a power consumption amount required for the sheet-discharge processing and is a total amount of power output by the Charger IC 304 to the DC-DC 306 during the sheet-discharge processing. Further, the power consumption amount Pd of the sheet-discharge processing varies depending on all factors relating to the sheet-discharge processing, such as the conveyance roller 418, the conveyance motor 420, and the time period Td required for the sheet-discharge processing. The power consumption amount Pm of the maintenance processing indicates a power consumption amount required for the maintenance processing, and, in the present embodiment, is an amount of power required to execute capping. In FIGS. 9A to 10D, in a case where the charged power amount Pc is stored in the EDLC 302, the charged power amount Pc exceeds the power consumption amount Pm of the maintenance processing. In FIGS. 9A to 10D , for ease of understanding, the USB cable is unplugged immediately after completion of the sheet-discharge processing.

In Comparative Example 1, after the print processing is performed, charging of the EDLC 302 (for example, an amount of power capable of executing the sheet-discharge processing and the maintenance processing) is performed, and then the sheet-discharge processing and the maintenance processing are executed (see FIG. 9A). Further, in Comparative Example 2, after charging of the EDLC 302 (for example, an amount of power capable of executing the print processing, the sheet-discharge processing, and the maintenance processing) is performed, the print processing, the sheet-discharge processing, and the maintenance processing are sequentially executed (see FIG. 9B). Accordingly, in Comparative Examples 1 and 2, the maintenance processing (capping) can be executed even in a case where the USB cable is unplugged at any timing after completion of charging.

In Comparative Examples 1 and 2, at the time of charging the EDLC 302, as illustrated in FIG. 11A, the power supply V_{BUS} supplied from the external device is used to charge the EDLC 302. Further, during the print processing and the sheet-discharge processing, in a case where the USB cable is not unplugged, as illustrated in FIG. 11B, the power supply V_{BUS} supplied from the external device is output to the DC-DC 306. Furthermore, during the maintenance processing after the USB cable is unplugged, as illustrated in FIG. 11C, the power supply V_{BAT} from the EDLC 302 is output to the DC-DC 306.

Thus, in Comparative Examples 1 and 2, the time period required for printing in the printing apparatus 10 is a summed value of the time period Tp required for the print processing, the time period Tc required for charging of the EDLC 302, the time period Td required for the sheet-discharge processing, and the time period Tm required for the maintenance processing.

On the other hand, in the exemplary embodiment, regardless of the setting of charge completion timing, charging of the EDLC 302 may be completed during the print processing, that is, before a timing at which completion of the print processing is determined in S620 (see FIG. 10A). In this case, there is no chance that charging of the EDLC 302 is solely performed. The amount of power charged to the EDLC 302, regardless of the setting of charge completion timing, is at least an amount of power capable of executing the maintenance processing.

In this case, in the period S1 during which the charging of the EDLC 302 overlaps with other processing, as illustrated in FIG. 11D, the power supply V_{BUS} supplied from the external device is used to charge the EDLC 302 while being output to the DC-DC 306. Further, in the period S2 during which the print processing or sheet-discharge processing is performed, since the USB cable is not unplugged, as illustrated in FIG. 11B, the power supply V_{BUS} is output to the DC-DC 306. Furthermore, during the maintenance processing, since the USB cable is unplugged, as illustrated in FIG. 11C, the power supply V_{BAT} from the EDLC 302 is output to the DC-DC 306.

Further, in this case, since the charging of the EDLC 302 is completed during the print processing, there is no chance that a time period occurs during which charging of the EDLC 302 is solely performed (that is, the time period Tc required for charging the EDLC 302). That is, in this case, the time period required for printing in the printing apparatus 10 is a summed value of the time period Tp required for the print processing, the time period Td required for the sheet-discharge processing, and the time period Tm required for the maintenance processing, which is shorter compared with Comparative Examples 1 and 2.

Further, in the exemplary embodiment, in a case where the setting of charge completion timing is before sheet-discharge processing, the charging of the EDLC 302 may not be completed during the print processing (see FIG. 10B). In this case, a time period during which the charging of the EDLC 302 is solely performed is provided after the print processing, before the sheet-discharge processing is started. The amount of power charged to the EDLC 302 in this case is also at least an amount of power capable of executing the maintenance processing.

In this case, in the period S1 during which the charging of the EDLC 302 overlaps with other processing, as illustrated in FIG. 11D, the power supply V_{BUS} is used to charge the EDLC 302 while being output to the DC-DC 306. Further, in the period S3 during which the charging of the EDLC 302 is solely performed, as illustrated in FIG. 11A, the power supply V_{BUS} is used to charge the EDLC 302. Furthermore, during the sheet-discharge processing, since the USB cable is not unplugged, as illustrated in FIG. 11B, the power supply V_{BUS} is output to the DC-DC. Moreover, during the maintenance processing, since the USB cable is unplugged, as illustrated in FIG. 11C, the power supply V_{BAT} from the EDLC 302 is output to the DC-DC 306.

Further, in this case, since the charging of the EDLC 302 is not completed during the print processing, a time period occurs during which charging of the EDLC 302 is solely performed. That is, in this case, the time period required for printing in the printing apparatus 10 is a summed value of the time period Tp required for the print processing, the time period Td required for the sheet-discharge processing, the time period Tm required for the maintenance processing, and the time period Tc required for charging of the EDLC 302. However, in the present embodiment of this case, since charging of the EDLC 302 is performed in parallel with the print processing, the time period Tc required to charge the EDLC 302, which is the time period dedicated to charging of the EDLC 302, is shorter than in Comparative Examples 1 and 2. Accordingly, in the exemplary embodiment, the time period required for printing is shorter compared with Comparative Examples 1 and 2.

Further, in the exemplary embodiment, in a case where the setting of charge completion timing is after sheet-discharge processing, the charging of the EDLC 302 may be completed during the sheet-discharge processing, that is, during execution of S640 (see FIG. 10C). In this case, there is no need to provide a time period during which the charging of the EDLC 302 is solely performed. The amount of power charged to the EDLC 302 in this case is also at least an amount of power capable of executing the maintenance processing.

In this case, in the period S1 during which the charging of the EDLC 302 overlaps with other processing, as illustrated in FIG. 11D, the power supply V_{BUS} is used to charge the EDLC 302 while being output to the DC-DC 306. Further, in the period S4 during which the sheet-discharge processing is solely performed, since the USB cable is not unplugged, as illustrated in FIG. 11B, the power supply V_{BUS} is output to the DC-DC. Furthermore, during the maintenance processing, since the USB cable is unplugged, as illustrated in FIG. 11C, the power supply V_{BAT} from the EDLC 302 is output to the DC-DC 306.

Further, in this case, since the charging of the EDLC 302, which is executed from the start of the print processing, is completed during the sheet-discharge processing, there is no chance that a time period occurs during which charging of the EDLC 302 is solely performed (that is, the time period Tc required for charging of the EDLC 302). That is, in this case, the time period required for print processing in the printing apparatus 10 is a summed value of the time period Tp required for the print processing, the time period Td required for the sheet-discharge processing, and the time period Tm required for the maintenance processing, which is shorter compared with Comparative Examples 1 and 2.

Furthermore, in the exemplary embodiment, in a case where the setting of charge completion timing is after sheet-discharge processing, the charging of the EDLC 302 may not be completed during the sheet-discharge processing (see FIG. 10D). In this case, a time period during which the charging of the EDLC 302 is solely performed is provided after the print processing, before the sheet-discharge processing is started. The amount of power charged to the EDLC 302 in this case is also at least an amount of power capable of executing the maintenance processing.

In this case, in the period S1 during which the charging of the EDLC 302 overlaps with other processing, as illustrated in FIG. 11D, the power supply V_{BUS} is used to charge the EDLC 302 while being output to the DC-DC 306. Further, in the period S3 during which the charging of the EDLC 302 is solely performed, as illustrated in FIG. 11A, the power supply V_{BUS} is used to charge the EDLC 302. Furthermore, during the maintenance processing, since the USB cable is unplugged, as illustrated in FIG. 11C, the power supply V_{BAT} from the EDLC 302 is output to the DC-DC 306.

Further, in this case, since the charging of the EDLC 302 is not completed even by utilizing the time period of the sheet-discharge processing, a time period occurs during which charging of the EDLC 302 is solely performed. That is, in this case, the time period required for printing in the printing apparatus 10 is a summed value of the time period Tp required for the print processing, the time period Td required for the sheet-discharge processing, the time period Tm required for the maintenance processing, and the time period Tc required for charging of the EDLC 302. However, in the present embodiment of this case, since charging of the EDLC 302 is performed in parallel with the print processing and the sheet-discharge processing, the time period Tc required to charge the EDLC 302, which is the time period dedicated to charging of the EDLC 302, is shorter than in Comparative Examples 1 and 2. Accordingly, in the exemplary embodiment, the time period required for printing is shorter compared with Comparative Examples 1 and 2.

Thus, in a case where the maximum supply power Psp of the external device is capable of sufficiently supplying the power consumption amount Pp of the print processing and the power consumption amount Pd of the sheet-discharge processing, in the exemplary embodiment, during the print processing and the sheet-discharge processing, a flow of current as illustrated in FIG. 11D occurs. In other words, in the exemplary embodiment, the power supply V_{BUS} supplied from the external device connected via the USB interface is used as an output to the DC-DC 306 to execute charging of the EDLC 302 while executing various kinds of processing. Accordingly, compared with Comparative Examples 1 and 2, in the exemplary embodiment, an increase in the time period required for printing in the printing apparatus 10 is suppressed.

Note that, in the exemplary embodiment, the timing of unplugging the USB cable is set immediately after the completion of the sheet-discharge processing; however, the timing of unplugging the USB cable is not limited to this. In the exemplary embodiment, once the charging is completed at the set charge completion timing or an earlier timing, even though the USB cable is unplugged at any timing after the charge completion timing, the capping can be executed.

### Functional Effect

As described above, in the present embodiment, during the time the print processing or the sheet-discharge processing is being executed, which allows the user to recognize that the printing apparatus is still in operation, the charging of the EDLC 302 is executed concurrently. Further, if the USB cable is unplugged, the maintenance processing is executed in accordance with the amount of power stored in the EDLC 302, and in a case where the maintenance processing cannot be executed, error information is stored. Accordingly, even in a case where the USB cable is unplugged at any timing after the sheet-discharge processing, the maintenance processing for the print head 404 can be executed after the USB cable is unplugged.

Further, by charging the EDLC 302 in parallel with the print processing and the sheet-discharge processing, the time period during which the charging of the EDLC 302 is solely performed can be shortened, as compared with a case where the charging of the EDLC 302 is performed at a timing different from the print processing and the sheet-discharge processing. Accordingly, an increase in the time period required for printing in the printing apparatus 10 is suppressed.

### Other Embodiments

Note that the above-described embodiments may be modified as shown in the following (1) through (8).

(1) In the above-described embodiment, capping of the print head 404 is executed as maintenance processing that is executed after sheet-discharge processing; however, there is no such limitation. Regarding the maintenance processing that is executed after sheet-discharge processing, any desired processing may be executed as long as it is one of various known processing for maintaining and recovering ink ejection performance of the print head 404. In this case, the power consumption amount Pm of the maintenance processing, the time period Tm required for the maintenance processing, and the like vary depending on the contents of the maintenance processing to be executed.

Further, in this case, in a case where the USB cable is unplugged and the amount of power stored in the EDLC 302 does not reach the power consumption amount of the maintenance processing (a NO determination in S650), the maintenance processing may be executed in accordance with the amount of power stored in the EDLC 302. For example, capping is preferentially executed, and other executable maintenance processing is executed.

Specifically, for example, the maintenance part 408 includes a configuration capable of creating a negative pressure inside the cap part 422. Further, as maintenance processing, the maintenance part 408 is capable of executing discharge processing that forcibly discharges ink from each nozzle by creating a negative pressure inside the cap part 422 in a capped state. In this case, capping is preferentially executed, and then, if an amount of power capable of executing the discharge processing is stored in the EDLC 302, the discharge processing is executed.

Furthermore, for example, the maintenance part 408 may include a wiper part that performs wiping of the nozzle surface 404a. Further, the maintenance part 408 can execute wiping as maintenance processing. In this case, if the amount of power capable of executing only capping is stored in the EDLC 302, only capping is executed. Further, for example, if an amount of power capable of executing capping and discharge processing is stored in the EDLC 302, capping and discharge processing are executed. Furthermore, if an amount of power capable of executing capping, discharge processing, and wiping is stored in the EDLC 302, discharge processing and wiping are executed, and then capping is executed. Note that, in this case, in accordance with the amount of power stored in the EDLC 302, the number of times the discharge processing is executed (the number of times discharge of ink is performed) and the number of times the wiping of the nozzle surface 404a is executed may be changed.

(2) In the above-described embodiment, if a predetermined amount of power including the power consumption amount Pm of the maintenance processing cannot be charged by the set charge completion timing (in the above-described embodiment, before sheet-discharge processing or after sheet-discharge processing), the difference from the predetermined amount of power is charged before sheet-discharge processing is started. However, the timing at which the difference is charged is not limited to before sheet-discharge processing is started. The timing for charging the difference may be before print processing is started or may be at a predetermined timing during execution of print processing. In a case where charging is performed before print processing is started, for example, the predetermined value A of the amount of power stored in the EDLC 302 is an amount of power obtained by subtracting, from the power consumption amount Pm of the maintenance processing, an amount of power supplied from an external device to be used for charging the EDLC 302 during a period up to the charge completion timing.

(3) Although not particularly mentioned in the above-described embodiment, a notification that prompts that the USB cable or the connection with an external device should not be disconnected until capping is completed may be displayed on the operation panel 208 or output by voice guidance. Further, although not particularly mentioned in the above-described embodiment, in a case where the USB cable is unplugged before charging of the EDLC 302 (charging of a predetermined amount of power including the power consumption amount Pm of the maintenance processing) is completed, a notification that prompts reconnection of the USB cable may be executed. In this case, the maintenance processing may be executed if the USB cable is reconnected before the printing apparatus 10 is completely shut down.

(4) Although not particularly mentioned in the above-described embodiment, the amount of power stored in the EDLC 302 may be monitored while each kind of processing is executed. In this case, for example, the amount of power stored in the EDLC 302 is detected at a predetermined cycle such as for each scan (printing by one scan of the print head 404), for each page, or for each job. Further, a configuration for checking the capacity of the EDLC 302 may be included.

(5) In the above-described embodiment, preliminary ejection is executed during a period after sheet-discharge processing until a predetermined period of time elapses; however, there is no such limitation. Not only preliminary ejection, but also other maintenance processing may be executed. Further, in the above-described embodiment, a USB cable is used as an interface cable; however, there is no such limitation, and various known cables may be used as the interface cable.

(6) In the above-described embodiment, the printing apparatus 10 is what is termed as a serial-scan type printing apparatus in which a print head that ejects ink while moving (scanning) in a direction intersecting with the conveyance direction of print media is used; however, there is no such limitation. The printing apparatus 10 may be what is termed as a full-line type printing apparatus, which uses a long print head extending over the whole area in the width direction of the printing area in a print medium.

(7) Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

(8) The above-described embodiments and various forms shown in (1) through (7) may be combined as appropriate.

According to the present disclosure, it is possible to suppress an increase in the time period required for printing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-041257, filed Mar. 14, 2025, which is hereby incorporated by reference herein in its entirety.

What is claimed is:

1. A printing apparatus including a power storage unit configured to be capable of storing power supplied from an external device connected via a connection unit, the printing apparatus being capable of executing processing to perform printing on a conveyed print medium by using the power as well as power stored in the power storage unit, the printing apparatus comprising:
a supply unit configured to supply power to a configuration configured to execute the processing; and
a control unit configured to control power supplied from the external device to be output to the supply unit and the power storage unit,
wherein, in a case where printing is performed, the control unit is configured to execute
outputting of power to the supply unit and the power storage unit in parallel until a predetermined timing in a case where power is supplied from the external device, and
outputting of power stored in the power storage unit to the supply unit in a case where supply of power from the external device is stopped, so as to execute predetermined processing in accordance with an amount of power stored in the power storage unit.

2. The printing apparatus according to claim 1, further comprising
a recovery unit configured to execute recovery processing for maintaining and recovering ejection performance of ink from nozzles of a printing unit configured to perform printing by ejecting ink from the nozzles,
wherein the control unit is configured to execute the recovery processing on a condition that an amount of power stored in the power storage unit in a case where supply of power from the external device is stopped is equal to or greater than an amount of power capable of executing the recovery processing.

3. The printing apparatus according to claim 2,
wherein the control unit is configured to
start the processing while outputting power to the supply unit and the power storage unit in parallel in a case where an amount of power supplied from the external device exceeds a first value, and
output power only to the power storage unit to store power in the power storage unit in a case where the amount of power supplied from the external device is equal to or less than the first value and then start the processing after an amount of power stored in the power storage unit reaches the first value.

4. The printing apparatus according to claim 2,
wherein the control unit is configured to
start the processing while outputting power to the supply unit and the power storage unit in parallel in a case where an amount of power stored in the power storage unit reaches a second value by the predetermined timing; and
output power only to the power storage unit to store power in the power storage unit in a case where the amount of power stored in the power storage unit does not reach the second value by the predetermined timing and then execute the processing after the amount of power stored in the power storage unit reaches the second value.

5. The printing apparatus according to claim 4,
wherein the second value is a value obtained by subtracting, from an amount of power capable of executing the recovery processing, an amount of power stored in the power storage unit by power supplied from the external device up to the predetermined timing.

6. The printing apparatus according to claim 2,
wherein, on a condition that an amount of power stored in the power storage unit in a case where supply of power from the external device is stopped is an amount of power incapable of executing the recovery processing, the control unit is configured to turn off a power supply of the printing apparatus and store information indicating that the power supply has been turned off.

7. The printing apparatus according to claim 6,
wherein the control unit is configured to execute the recovery processing on a condition that the information is stored and power is supplied from the external device in a case where the printing apparatus is turned on.

8. The printing apparatus according to claim 2,
wherein the predetermined timing is a timing at which storing of an amount of power capable of executing the recovery processing into the power storage unit is completed.

9. The printing apparatus according to claim 8,
wherein the control unit is configured to execute outputting of power only to the power storage unit at a first timing, a second timing, or a third timing in a case where an amount of power capable of executing the recovery processing cannot be stored by the predetermined timing, the first timing being before starting print processing in which ink is ejected onto a print medium for printing, the second timing being during the print processing, and the third timing being after the print processing and before sheet-discharge processing in which the print medium on which printing has been performed by the print processing is discharged.

10. The printing apparatus according to claim 2,
wherein the recovery unit includes a cap part configured to perform capping in which the cap part abuts against a nozzle surface on which the nozzles of the printing unit are formed, and
wherein the control unit is configured to perform the capping as the recovery processing that is executed in a case where supply of power from the external device is stopped.

11. The printing apparatus according to claim 10,
wherein the recovery unit
further includes a configuration capable of creating a negative pressure inside the cap part, and
is further configured to execute, as the recovery processing, discharge processing for forcibly discharging ink from the nozzles by creating a negative pressure inside the cap part in a capped state, and
wherein the control unit is configured to preferentially execute the capping in accordance with an amount of power stored in the power storage unit in a case where supply of power from the external device is stopped.

12. The printing apparatus according to claim 11,
wherein the recovery unit further includes a wiper part configured to perform wiping on the nozzle surface, and
wherein the control unit is configured to preferentially execute the capping in accordance with the amount of power stored in the power storage unit in a case where supply of power from the external device is stopped.

13. The printing apparatus according to claim 12,
wherein, in a case where the control unit is configured to execute the capping, the discharge processing, and the wiping as the recovery processing on a condition that supply of power from the printing apparatus is stopped, the control unit is configured to execute the capping after executing the discharge processing and the wiping.

14. The printing apparatus according to claim 13,
wherein, in the recovery processing that is executed in a case where supply of power from the external device is stopped, the control unit is configured to change the number of times the discharge processing and the wiping are executed in accordance with the amount of power stored in the power storage unit.

15. The printing apparatus according to claim 1,
wherein the predetermined timing is settable to any desired timing.

16. The printing apparatus according to claim 1,
wherein the predetermined timing is a uniquely set timing.

17. A control method of a printing apparatus including a power storage unit configured to be capable of storing power supplied from an external device connected via a connection unit, the printing apparatus being capable of executing processing to perform printing on a conveyed print medium by using the power as well as power stored in the power storage unit, the control method comprising:
outputting power to a supply unit and the power storage unit in parallel until a predetermined timing in a case where power is supplied from the external device in a case where printing is performed, the supply unit being configured to supply power to a configuration configured to execute the processing; and
outputting power stored in the power storage unit to the supply unit in a case where supply of power from the external device is stopped in a case whereprinting is performed, so as to execute predetermined processing in accordance with an amount of power stored in the power storage unit.

18. A non-transitory computer readable storage medium storing a program for causing a computer to perform a control method of a printing apparatus,
wherein the printing apparatus
includes a power storage unit configured to be capable of storing power supplied from an external device connected via a connection unit, and is capable of executing processing to perform printing on a conveyed print medium by using the power as well as power stored in the power storage unit, and
wherein the control method comprises:
outputting power to a supply unit and the power storage unit in parallel until a predetermined timing in a case where power is supplied from the external device in a case where printing is performed, the supply unit being configured to supply power to a configuration configured to execute the processing; and
outputting power stored in the power storage unit to the supply unit in a case where supply of power from the external device is stopped in a case where printing is performed, so as to execute predetermined processing in accordance with an amount of power stored in the power storage unit.
